(19) United States
(12) Patent Application Publication
(10) Pub. No.: US 2025/0244188 A1
(43) Pub. Date: Jul. 31, 2025

(54) A SENSOR DEVICE FOR CONTACTING HYDROGEN, USING SUCH A SENSOR DEVICE IN A FUEL CELL SYSTEM, IN A HYDROGEN HIGH-PRESSURE STORAGE SYSTEM, IN A HYDROGEN COMBUSTION ENGINE SYSTEM, OR IN A HYDROGEN DISTRIBUTION SYSTEM, METHODS FOR MANUFACTURING SUCH A SENSOR DEVICE

(71) Applicant: Robert Bosch GmbH, Stuttgart (DE)

(72) Inventors: Patrick Fayek, Leonberg (DE); Thomas Woehrle, Heilbronn (DE)

(21) Appl. No.: 18/854,163

(22) PCT Filed: Feb. 13, 2023
(86) PCT No.: PCT/EP2023/053445

§ 371 Date: Oct. 4, 2024

(30) Foreign Application Priority Data
Apr. 4, 2022 (DE) 10 2022 203 330.2

(51) Int. Cl. G01L 19/06; H01M 8/0438

(52) U.S. Cl. CPC G01L 19/0627; H01M 8/04388

(57) ABSTRACT

The present invention relates to a sensor device (1) for contacting hydrogen, comprising a sensor membrane (11) intended to come into contact with a hydrogen atmosphere. Further, the sensor membrane (11) comprises at least one stainless or rust-resistant steel or a steel comprising a nickel-based alloy and the sensor membrane (11) comprises a hydrogen protection layer (20).

In addition, the invention relates to methods of manufacturing such a sensor device (1) for contacting hydrogen.

### BACKGROUND

The present invention relates to a sensor device suitable for and intended to be in contact with hydrogen. The present invention relates in particular to a sensor device, which may be a component of a fuel cell system, a hydrogen high-pressure storage system, a hydrogen combustion engine system, or a hydrogen distribution system. The present invention further relates to a method of manufacturing such a sensor device.

Typically, components in, for example, fuel cell systems or high-pressure storage systems have a high mechanical stability. In addition to this mechanical stability, it is often also required that they have a high degree of media resistance. Particularly in fuel cell systems, hydrogen combustion engine systems, hydrogen high-pressure storage systems or even in hydrogen distribution systems, a high hydrogen resistance is required.

Document DE 10 2012 219 061 A1 describes a fuel cell system having a hydrogen pressure tank from which hydrogen can be taken to supply at least one anode of the fuel cell system. To ensure a long service life for the fuel cell system or the hydrogen pressure tank, a high hydrogen resistance is therefore necessary for the components of the fuel cell system and the hydrogen pressure tank.

Sensor devices in particular must have high hydrogen resistance in order to operate safely and reliably. Materials currently in use for sensor membranes in sensor devices are, for example, precipitation hardening martensitic stainless steels (maraging steels, e.g., 1.4542). However, these are characterized by a high susceptibility to hydrogen embrittlement, which makes them difficult to use in terms of safety technology. In addition, this class of materials shows a high hydrogen permeation, which can lead to an impairment of the mechanical material properties and to interference with the measurement signal of the sensor device.

Stainless austenitic stainless steels are often used as an alternative to maraging steels. However, these have comparatively low strength levels. Higher thicknesses are thus necessary when using them as sensor membranes in sensor devices. The elastic deformations achievable by the applied pressure are relatively small when using higher membrane thicknesses. The measurement of the pressure signal may in this case not be used directly for a pressure measurement with sufficient accuracy due to the low level of elastic deformation.

When exposed to a hydrogen atmosphere and mechanical stress, steel materials may exhibit a degradation of their mechanical properties, which is referred to as hydrogen embrittlement. The propensity to embrittlement is dependent on factors such as, for example, the material's microstructure (e.g., ferritic, martensitic, austenitic) and strength, as well as on the introduction of hydrogen into the material or the component. One way to minimize hydrogen embrittlement is to disrupt or inhibit the introduction of hydrogen into the material.

### SUMMARY

The device according to the disclosure has the advantage that hydrogen introduction into the device can be minimized in a simple manner, thereby likewise minimizing the risk of hydrogen embrittlement simply.

For this purpose, the sensor device for contacting hydrogen comprises a sensor membrane that is intended to come into contact with a hydrogen atmosphere. Moreover, the sensor membrane comprises at least one stainless or rust-resistant steel or steel containing a nickel-based alloy, and the sensor membrane comprises a hydrogen protection layer.

The hydrogen protection layer provides protection for the sensor device against hydrogen embrittlement. Further, the mechanical properties of the sensor device are thus maintained, so as to ensure reliable and accurate operation of the sensor device.

In the first advantageous further development, it is contemplated that the stainless or rust-resistant steel may comprise martensitic steels such as 1.4542, 1.4418, or 1.4034.

Advantageously, the hydrogen protection layer comprises alumina or silica.

Thus, hydrogen embrittlement of the sensor device can be minimized simply through the materials selected. In addition, such materials make it possible to allow for a lower membrane thickness due to their high elasticity without plastic deformation in response to applied pressures. Higher elastic deformations result in more accurate and simpler pressure measurements.

In an advantageous further development, it is provided that the hydrogen protection layer has a thickness t of between 0.1 μm and 5 μm.

Furthermore, according to the invention, the use of the sensor device for a fuel cell system is proposed.

Furthermore, according to the invention, the use of the sensor device for a hydrogen high-pressure storage system is proposed.

Furthermore, according to the invention, the use of the sensor device for a hydrogen internal combustion engine system is proposed.

Furthermore, according to the invention, the use of the sensor device for a hydrogen distribution system is proposed.

The invention further relates to a method of manufacturing a sensor device for contacting hydrogen, comprising the method steps of:
a) fabricating a sensor device from rod-shaped, sheet-shaped or plate-shaped raw material,
b) generating a hydrogen protection layer on the sensor device by applying aluminum and/or silicon,
c) exposing the sensor device to an atmosphere, for example air, in a temperature range of between 450 degrees Celsius and 1100 degrees Celsius and a time range of between 0.5 hours and 3 hours for thermal treatment of the sensor device for forming alumina and/or silica.

The invention also relates to a method of manufacturing a sensor device for contacting hydrogen, comprising the method steps of
a) fabricating a sensor device from rod-shaped, sheet-shaped or plate-shaped raw material,
b) generating a hydrogen protection layer on the sensor device by applying alumina and/or silica via CVD (chemical vapor deposition).

The invention also relates to a method of manufacturing a sensor device for contacting hydrogen, comprising the method steps of
a) fabricating a sensor device from rod-shaped, sheet-shaped or plate-shaped raw material,
b) generating a hydrogen protection layer on the sensor device by applying alumina and/or silica via PVD (physical vapor deposition).

The invention also relates to a method of manufacturing a sensor device for contacting hydrogen, comprising the method steps of
a) fabricating a sensor device from rod-shaped, sheet-shaped or plate-shaped raw material,
b) generating a hydrogen protection layer on the sensor device by applying alumina and/or silica via dip coating.

Thus, the sensor device may be easily provided with a protective layer that protects the sensor device from hydrogen embrittlement and from mechanical damage caused by contact with hydrogen. Furthermore, optimal and reliable operation of the sensor device can thus also be achieved.

### BRIEF DESCRIPTION OF THE DRAWINGS

An exemplary embodiment of a sensor device according to the invention for contacting hydrogen and for use in a fuel cell system, a hydrogen high-pressure storage system, a hydrogen combustion engine system and a hydrogen distribution system are shown in the drawing. The following are shown:

FIG. 1 a possible exemplary embodiment of a sensor device for contacting hydrogen in a simplified schematic view,

FIG. 2 use of the exemplary embodiment of FIG. 1 in a fuel cell system, a hydrogen high-pressure storage system, a hydrogen internal combustion engine system, and a hydrogen distribution system in a simplified schematic view,

FIG. 3 process flowchart for manufacturing a sensor device for contacting hydrogen.

### DETAILED DESCRIPTION

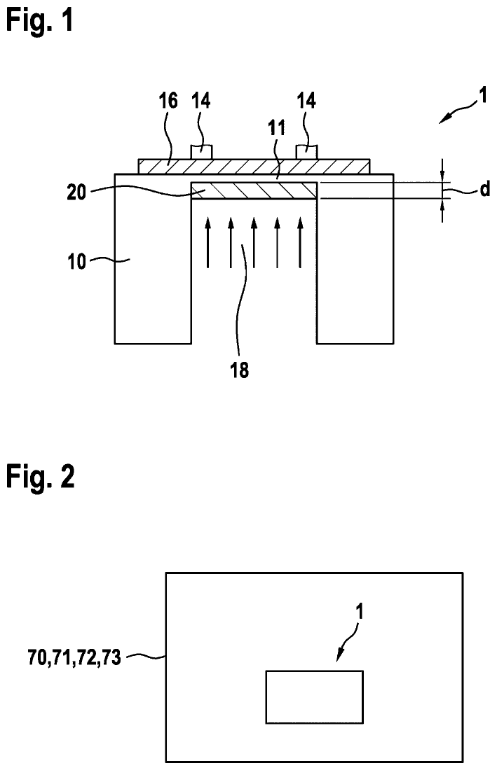

FIG. 1 shows a possible exemplary embodiment of a sensor device 1 for contacting hydrogen in a simplified schematic view. The sensor device 1 comprises a sensor element housing 10 having a sensor membrane 11, which is provided to come into contact with hydrogen on a pressurized side 18. A hydrogen protection layer 20 is formed on this pressurized side 18.

The pressure of the medium, here hydrogen, leads to elastic deformation in the sensor membrane 11. A glazed electrical separation layer 16 with separate component elements 14 is also disposed on the sensor membrane 11, for example a Wheatstone bridge, in which the elastic deformation is converted into a change in resistance, which can be associated with a pressure. In this way, it is possible to use the sensor device 1 for pressure detection.

The sensor membrane 11 comprises at least one stainless or rust-resistant steel or a steel comprising nickel base alloys. For example, the stainless or rust-resistant steel could comprise martensitic steels, such as 1.4542, 1.4418, or 1.4034.

Further, the sensor membrane 11 comprises the hydrogen protection layer 20. This comprises alumina or silica. Further, the hydrogen protection layer 20 has a thickness t of between 0.1 μm and 5 μm.

The sensor device 1 is used in a fuel cell system 70, a hydrogen high-pressure storage system 71, a hydrogen internal combustion engine system 72, or a hydrogen distribution system 73 (see FIG. 2).

The invention further relates to a method 500 for manufacturing a sensor device 1 for contacting hydrogen comprising the method steps of
a) fabricating 50 a sensor device 1 from rod-shaped, sheet-shaped or plate-shaped raw material,
b) generating 51 a hydrogen protection layer 20 on the sensor device 1 by applying aluminum and/or silicon,
c) exposing 52 the sensor device 1 to an atmosphere, for example, such as air in a temperature range of between 450 degrees Celsius and 1100 degrees Celsius and a time range of between 0.5 hours and 3 hours for thermal treatment of the sensor device 1 to form alumina and/or silica.

The invention further relates to a method 500 for manufacturing a sensor device 1 for contacting hydrogen comprising the method steps of
a) fabricating 50 a sensor device 1 from rod-shaped, sheet-shaped or plate-shaped raw material,
b) generating 51 a hydrogen protection layer 20 on the sensor device 1 by applying alumina and/or silica via CVD (chemical vapor deposition).

An initial material needed for the production of the hydrogen protection layer is heated and the hydrogen protection layer 20 is formed on the sensor membrane 11 by a chemical reaction on the initial material.

The invention further relates to a method 500 for manufacturing a sensor device 1 for contacting hydrogen comprising the method steps of
a) fabricating 50 a sensor device 1 from rod-shaped, sheet-shaped or plate-shaped raw material,
b) generating 51 a hydrogen protection layer 20 on the sensor device 1 by applying alumina and/or silica by PVD (physical vapor deposition).

A physical method is used to transfer the material used for the hydrogen protection layer to the gas phase and applied to the sensor device 1, in particular the sensor membrane 11, and the hydrogen protection layer is formed on the sensor membrane 11 by condensation.

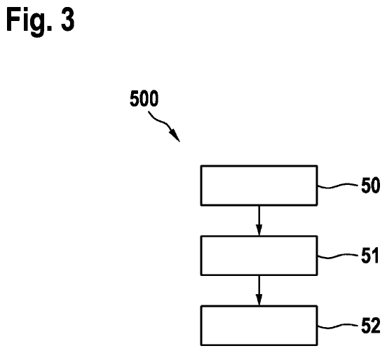

The invention further relates to a method 500 for manufacturing a sensor device 1 for contacting hydrogen comprising the method steps of
a) fabricating 50 a sensor device 1 from rod-shaped, sheet-shaped or plate-shaped raw material,
b) generating 51 a hydrogen protection layer 20 on the sensor device 1 by applying alumina and/or silica by dip coating.
c) The dip coating is a possible form of CVD (chemical vapor deposition), wherein the sensor device 1 is immersed in a solution and the hydrogen protection layer solidifies and forms on the sensor device 1 by a chemical reaction.
d) FIG. 3 shows a possible flowchart of the aforementioned method 500 comprising the method steps of 50, 51, 52.

1. A sensor device (1) for contacting hydrogen comprising a sensor membrane (11) configured to come into contact with a hydrogen atmosphere, wherein the sensor membrane (11) comprises at least one stainless steel or rust-resistant steel or a steel comprising a nickel base alloy, and that the sensor membrane (11) comprises a hydrogen protection layer (20).

2. The sensor device (1) according to claim 1, wherein the stainless or rust-resistant steel comprises martensitic steels such as 1.4542, 1.4418, or 1.4034.

3. The sensor device (1) according to claim 1, wherein the hydrogen protection layer (20) comprises alumina or silica.

4. The sensor device (1) according to claim 1, wherein the hydrogen protection layer (20) has a thickness t of between 0.1 μm and 5 μm.

5. (canceled)

6. (canceled)

7. (canceled)

8. (canceled)

9. A method (500) of manufacturing a sensor device (1) for contacting hydrogen, the method comprising:
a) fabricating (50) the sensor device (1) from rod-shaped, sheet-shaped or plate-shaped raw material,
b) generating (51) a hydrogen protection layer (20) on the sensor device (1) by applying aluminum and/or silicon, and
c) exposing (52) the sensor device (1) to an atmosphere, for example air, in a temperature range of between 450 degrees Celsius and 1100 degrees Celsius and a time range of between 0.5 hours and 3 hours for thermal treatment of the sensor device (1) to form alumina and/or silica.

10. A method (500) of manufacturing a sensor device (1), for contacting hydrogen, the method comprising:
a) fabricating (50) a sensor device (1) from rod-shaped, sheet-shaped or plate-shaped raw material, and
b) generating (51) a hydrogen protection layer (20) on the sensor device (1) by applying alumina and/or silica via CVD (chemical vapor deposition) or via PVD (physical vapor deposition).

11. (canceled)

12. The method (500) of manufacturing a sensor device (1) according to claim 10, further comprising
a) generating (51) a hydrogen protection layer (20) on the sensor device (1) by applying alumina and/or silica by dip coating instead of generating (51) a hydrogen protection layer (20) on the sensor device (1) by applying alumina and/or silica via CVD (chemical vapor deposition) or via PVD (physical vapor deposition).
